(19) United States
(12) Patent Application Publication
(10) Pub. No.: US 2007/0134046 A1
(43) Pub. Date: Jun. 14, 2007

(54) Mechanical pencil

(76) Inventors: Franck Rolion, Belloy (FR); Frederic Duchesne, St. Ouen L'Aumone (FR); Jeanne-Antide Bouveresse, Reuil Malmaison (FR)

Correspondence Address: JONES DAY, 222 EAST 41ST ST, NEW YORK, NY, 10017, US

(21) Appl. No.: 10/577,007

(22) PCT Filed: Oct. 18, 2004
(86) PCT No.: PCT/FR04/02659

§ 371 Date: Apr. 24, 2006

(30) Foreign Application Priority Data
Oct. 22, 2003 (FR) 0312333

(51) Int. Cl. B43K 21/22

(52) U.S. Cl. 401/93

(57) ABSTRACT

A mechanical pencil that includes a body extending between a rear end and a front end, and a lead-advancing mechanism that includes a movable member having a bearing surface; a chuck connected to the movable member; a clamping ring cooperating with the head of the chuck; and an elastic element having a rear end bearing against the bearing surface. The elastic element stresses the ring against the head when the advancing mechanism is in the rest position. A movable bush is arranged between the clamping ring and the front end of the elastic element. The chuck is movable with respect to the movable member over a defined stroke. The body has a stop to limit the forward displacement of the bush.

This application is a national stage application of PCT/FR2004002659, filed on Oct. 22, 2003.

### FIELD OF THE INVENTION

The embodiments of the present invention described herein relate to a mechanical pencil and, more particularly, to a mechanical pencil comprising a tubular body extending along a longitudinal axis between a rear end and a front end provided with an orifice, through which a lead is capable of emerging.

### BACKGROUND OF THE INVENTION

It is known, for mechanical pencils of this type, to provide the possibility of a rearward movement of the pencil when the user exerts too great a pressure on the latter and in order to prevent the lead from breaking. To obtain a retraction of the lead, and as described, for example in U.S. Pat. No. 4,371,277, the body of the mechanical pencil comprises an additional elastic means, of which the rear end bears on the body of the mechanical pencil and the front end bears on the clamping ring or, if appropriate, on a sleeve bearing on the clamping ring, so as to allow a rearward retraction movement of the advancing mechanism as a whole, that is to say including the movable member. Most often, the movable member is a tube which forms a lead reservoir and in which the rear end of the chuck is force-fitted.

However, this additional elastic means, which may consist of a compression spring or of a portion of elastically deformable tube, increases the number of parts, complicates the assembly of the mechanical pencil and increases the space necessary in the tubular body for accommodating the mechanism as a whole, this having an adverse affect on the manufacturing cost.

### SUMMARY OF THE INVENTION

The object of the present invention is to mitigate the above-mentioned disadvantages by proposing a mechanical pencil which allows a rearward movement of the lead and which has a simplified structure, in order, in particular, to reduce its manufacturing cost. The rearward movement of the lead must, of course, be elastic, in such a way that the latter returns into the writing position as soon as the user ceases exerting excessive pressure on the said lead.

To achieve this, the subject of an embodiment of the present invention is a mechanical pencil of the abovementioned type, characterized in that a bush, movable longitudinally with respect to the chuck and to the body, is arranged between the clamping ring and the front end of the elastic element, in that the chuck is movable longitudinally with respect to the movable member over a defined stroke, called the rearward stroke, and in that the body has a front stop designed to limit the forward displacement of the bush.

By virtue of this arrangement, only one elastic element is sufficient for both clamping the head of the chuck with the aid of the ring and allowing an elastic rearward movement of the lead when the user exerts excessive pressure. this makes it possible to reduce the number of parts and the overall size of the mechanism of the mechanical pencil.

It is noted that this arrangement makes it possible to allow a retraction of the lead, without necessarily bringing about a rearward movement of the movable member, thus affording the advantage of not having any effect on the means for controlling the movable member and, especially, of not causing a displacement of said means towards the outside of the body, whether they consist of a pushbutton arranged at the rear end of the body or of a lateral button movable in a radial direction of the body.

In preferred embodiments of the present invention, furthermore, use may be made of either or both of the following arrangements in which:
The front stop is formed by a radially inner rim which cooperates with a peripheral portion of the front end of the bush;
the elastic element is a helical compression spring;
the tubular portion of the chuck has, from its rear end, first and second radially outer rims, and the front end of the movable member has an orifice, through which the chuck slides between the first and the second rims, said first and second rims being spaced apart longitudinally in order to limit this sliding of the chuck to a value equal to the rearward stroke;
the tubular portion of the chuck has a frustoconical portion extending from the first rim as far as the rear end of the chuck, in order to make it possible to mount the chuck by snapping in the movable member;
the body has a rear stop designed to cooperate with a complementary stop of the movable member and to limit the rearward displacement of the movable member, the longitudinal distance between the front stop of the body and said rear stop being designed so that the clamping ring keeps the chuck clamped under the action of the bush when the advancing mechanism is in the rest position;
the rear stop is formed by a radially inner rim of the body, the said rim cooperating with a radially outer shoulder of the movable member;
the body has an aperture extending longitudinally as far as a rear end, and the movable member has a pin projecting into the aperture, the rear end of the aid aperture forming the rear stop;
at least one elastically deformable compensation member is arranged between the front stop of the body and the bush or between the rear stop of the body and the complementary stop of the movable member, in order to compensate possible play between the advancing mechanism and the stops of the body;
the compensation member comprises at least one tab elastically deformable in a longitudinal direction and produced in one piece with the body;
the body has a rearward movement stop designed to limit the rearward displacement of the clamping ring, from the rest position of the advancing mechanism, to a value at most equal to the rearward stroke of the chuck, so as to increase the clamping of the chuck and prevent a sliding of the lead;
the rearward movement stop is formed by at least one stud integral with the body and extending radially inwards between the bush and the movable member, said stud being designed to limit the rearward displacement of the bush;
the rearward movement stop is formed by a radially inner rim of the body, said rim being designed to cooperate with a radially outer shoulder of the clamping ring;
the chuck is capable of driving the lead forwards over a defined stroke, called the advancing stroke, said advancing stroke being substantially equal to half the rearward stroke;
the chuck is capable of driving the lead forward over a defined stroke, called the advancing stroke, said advancing stroke being substantially equal to half the rearward stroke;
the elastic element is designed to exert on the bush a pressure of between 2 and 5 newtons, preferably 3 newtons, when the advancing mechanism is in the rest position, and a pressure of between 5 and 10 newtons, preferably 8 newtons, when the chuck has executed a rearward displacement substantially equal to the rearward stroke.

### BRIEF DESCRIPTION OF THE DRAWINGS

Other characteristics and advantages of the invention will become apparent from the following description given by way of non-limiting example, with reference to the accompanying drawings in which:

FIG. 1 is a view in longitudinal section of a mechanical pencil according to a first embodiment of the invention, and in which a lead-advancing mechanism is in the rest position;

FIG. 2 is an enlarged view of a front portion of a mechanical pencil illustrated in FIG. 1;

FIG. 3 is a view similar to FIG. 2, in which the advancing mechanism has executed a first forward stroke;

FIG. 4 is a view similar to FIG. 2, in which the advancing mechanism has executed a second forward stroke;

FIG. 5 is a view similar to FIG. 2, in which the advancing mechanism has executed a rearward stroke;

FIG. 6 is an enlarged perspective view of an element of the mechanical pencil illustrated in FIG. 1;

FIG. 7 is a partial view of a longitudinal half-section through a mechanical pencil according to a second embodiment of the invention, and which the advancing mechanism is in the rest position;

FIG. 8 is a view similar to FIG. 7, in which the advancing mechanism has executed a rearward stroke.

The same references have been retained in the various figures in order to designate identical or similar elements.

### DETAILED DESCRIPTION OF THE INVENTION

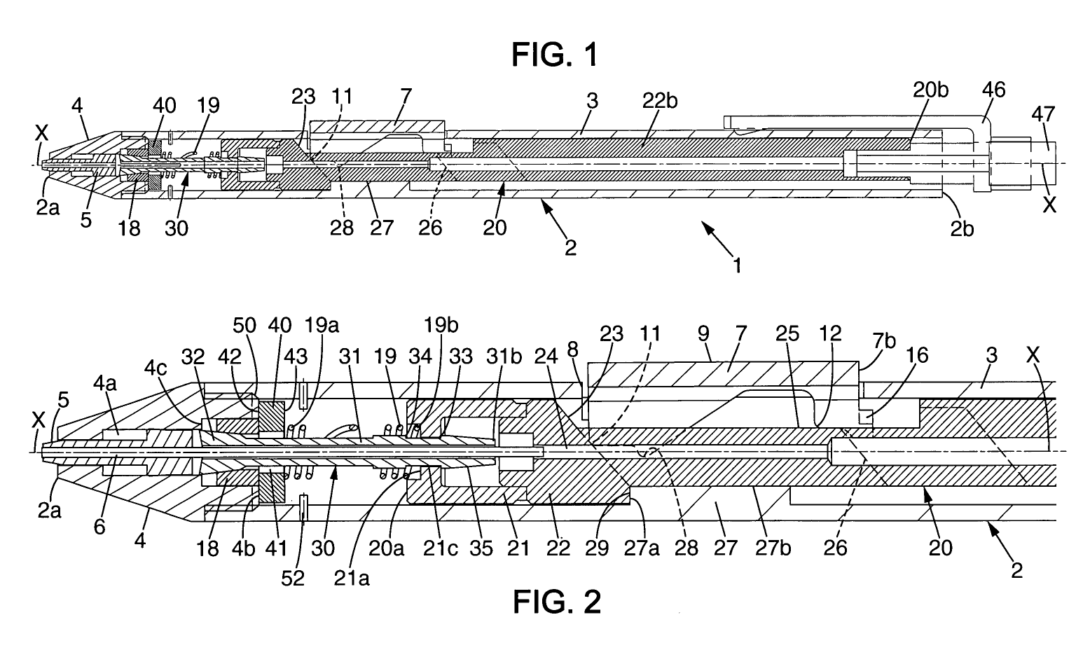

A first embodiment of a mechanical pencil is illustrated in FIGS. 1 to 5.

The mechanical pencil 1 comprises a tubular body 2 which extends along a longitudinal axis X between a front end 2a and a rear end 2b.

The body 2 is formed from a tube 3 and from a tip 4 arranged at the front end of the body 2.

The tip 4 has at its front end an orifice, through which passes a lead guide tip 5 which is mounted freely slidably in a bore 4a of the tip 4. The lead guide tip 5 accompanies the emergence of the lead 6 in order to prevent a break of the lead. When the wear of the lead reaches the end of the lead guide tip, the latter touches the paper and executes a retraction movement, thus freeing the end of the lead and making it possible to continue writing.

A lateral button 7 is mounted through a rectangular aperture 8 formed in the radial wall of the tubular body 2 and extending along the longitudinal axis X. The lateral button 7 has an actuation surface 9 oriented radially outwards.

The lateral button 7 comprises a first pair of cams 11 arranged opposite the actuation face 9 at the front end of the lateral button, said front end having a U-shaped cross section.

The rear end 7b of the lateral button, likewise of U-shaped cross section, has a second pair of cams 12 in a similar way to the front end.

It will be noted that the first pair of cams 11 is spaced apart from the second pair of cams 12 by a significant distance, measured along the axis X, which is near the longitudinal length of the actuation face 9 of the lateral button 7.

The portion of the lateral button 7 which is located inside the body 2 comprises pins, especially a pin 16 which projects towards the rear end 2b of the body 2, which cooperate with the inner perimeter of the aperture 8 and thus prevent the complete emergence of the lateral button 7 from the tubular body 2.

Inside the tubular body 2 is arranged an advancing mechanism which comprises a movable member 20, a chuck 30, a bush 40, a clamping ring 18 and a compression spring 19 arranged between the movable member 20 and the bush 40.

The rear end 20b of the movable member is equipped with an element 46 projecting through the rear end 2b of the body. The element 46 comprises a tubular part, a clip and a cylindrical recess in which is mounted a rubber 47. The element 46 and the rubber 487 form a rear button which makes it possible to displace the movable member 20 forwards.

The movable member 20 is mounted slidably along the longitudinal axis X in the tubular body 2. In the embodiment illustrated, the movable member 20 comprises a front part 21, which forms the front end 20a of the movable member, and a main part 22 fastened to the front part 21. The main part 22 comprises a first portion located towards the front end 20a of the movable member, which portion will be described in detail later, and a hollow rear portion 22b which forms a lead reservoir. However, it is perfectly possible for the lead reservoir to be formed by an independent part fastened to the movable member 20.

The front part 21 of the movable member has a depression which is oriented towards the front end 2a of the body and the bottom 21a of which forms a bearing surface with the spring 19.

The front part 21 of the movable member has a depression which is oriented towards the front end 2a of the body and the bottom 21a of which forms a bearing surface with the spring 19.

The front portion of the main part 22 of the movable member 20 has a first pair of identical ramps 23 arranged towards the front end 20a of the movable member. The first ramps 23 are located on either side of the central duct 24 allowing the leads to pass from the reservoir 22b towards the chuck 30. Each first ramp 23 has a rectilinear surface inclined with respect to the longitudinal axis X and oriented towards the rear of the body 2.

Thus, when pressure is exerted on the lateral button 7 from the rest position illustrated in FIGS. 1 and 2, the first pair of cams 11 cooperates with the first paid of ramps 23 and causes a displacement for the movable member 20 toward the front end 2a.

A bearing 25 parallel to the longitudinal axis X is formed on that face of the movable member 20 which confronts the lateral button 7. The bearing 25 extends on either side of the duct 24 and is positioned longitudinally in such a way that the second pair or cams 12 of the lateral button 7 can bear on the latter when the lateral button is in the rest position.

A second pair of ramps 26 immediately follows the rear end of the bearing 25. The second ramps 26 are located on either side of the pencil reservoir and are inclined with respect to the longitudinal axis in a similar way to the first ramps 23.

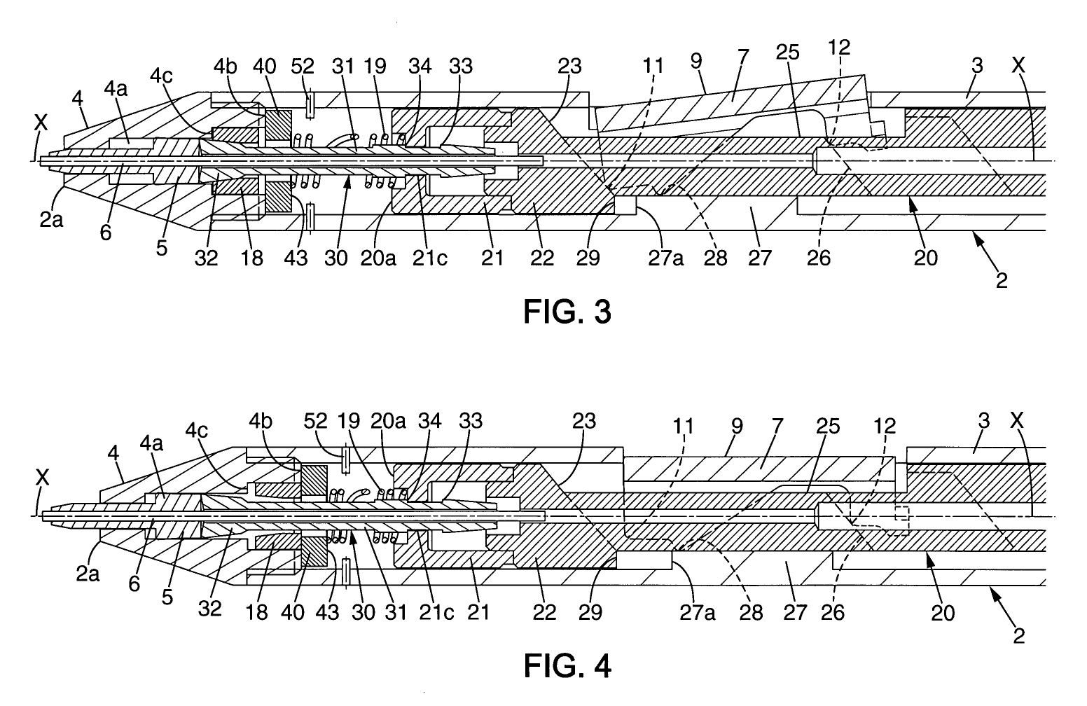

The second ramps 26 are spaced apart longitudinally from the first ramps 23, in such a way that the second pair of cams 12 confronts the second ramps 26 when the lateral button 7 has executed a first tilting movement and is in the position illustrated in FIG. 3.

The body 2 of the mechanical pencil comprises a rim 27 which extends radially inwards and which has a surface 27b parallel to the longitudinal axis X and confronting the aperture 8 of the body, against which surface 27b a projecting boss 28 comes into abutment at the end of the first tilting movement of the button.

The front end of the rim 27 has a forwardly oriented transverse surface 27a which forms a stop, called a rear stop, against which a radially outer shoulder 29 of the movable member comes into abutment. The rear stop 27a thus makes it possible to limit the rearward of the movable member 20.

The chuck 30 comprises a tubular portion 31 and a head 32 which cooperates in a known way with the clamping ring 18 in order to immobilize the lead 6.

In the embodiments illustrated, the tubular portion 31 extends from a rear end 31b as far as the head 32 located towards the front end 2a of the body.

The tubular portion 31 has, on its rear end 31b, a first rim 33 projecting outwards in a radial direction perpendicular to the longitudinal axis X, and a likewise radially outer second rim 34.

The tubular portion 31 of the chuck has a frustoconical portion 35 extending from the first rim 33 as far as the rear end 31b, that is to say the conicity of the portion 35 is oriented towards the rear end of the chuck. The chuck can thus be mounted through the orifice 21 c of the movable member 20 by snapping.

The front end of the movable member 20, said front end being formed by the front part 21, has an orifice 21 c, through which the tubular portion 31 of the chuck is mounted slidably along the longitudinal axis X between the first rim 33 and the second rim 34. The first 33 and second 34 rims are spaced apart longitudinally so as to allow a longitudinal sliding of the chuck 30 with respect to the movable member 20 over a defined length, called the “rearward stroke” below.

The bush 40 is mounted slidably in the body 2 of the mechanical pencil and is likewise movable longitudinally with respect to the chuck 30. In the first embodiment illustrated, the bush 40 is a cylindrical part which has a central orifice 41, through which the tubular portion 31 of the chuck passes, a front end face 42 and a rear end face 43 of plane annular shape. The bush 30 could, however, have a different shape, such, as for example, a dish shape.

It will be noted that the front annular face 42 of the bush extends over a sufficient radial distance to come to bear both against the clamping ring 18 and against a radially inner rim of the body 2, the said rim being formed by the rear end 4b of the tip 4. The rear end 4b of the tip thus forms a stop integral with the body 2, called a front stop, which limits the displacement of the bush 40 towards the front end 2a of the body when the peripheral portion of the front end 43 of the ring comes into contact with the said stop.

The spring 19 has a front end 19a bearing against the rear face 43 of the bush and a rear end 19b bearing against the bearing surface 21a of the movable member, so that the spring keeps the bush 40 as far as possible from the movable member 20.

It will be noted that the distance between these two parts is limited by the chuck 30, the first rim 33 of which cooperates with the orifice 21c of the movable member, the head 32 of which limits the forward displacement of the ring 18 which itself limits the forward displacement of the bush 40. The advancing mechanism thus forms a unit which can be preassembled before it is introduced into the body 2 of the mechanical pencil via the front end of the tube 3, thus making it easier to assemble the mechanical pencil.

It is preferable that the front stop 4b and the rear stop 27a of the body are spaced apart sufficiently to allow a maximum distance between the bush 40 and the movable member 20 when the advancing mechanism is in the rest position. To be precise, if the spacing between the front stop 4b and rear stop 27a is not sufficient, the bush 40 cannot push the ring 18 on the head 32 in a sufficiently advanced manner to ensure a maximum clamping of the head of the chuck on the lead 6.

Owing to the manufacturing tolerances of the elements forming the body 2 and the advancing mechanism, it is preferable that the front 4b and rear 21a stops are spaced apart in such a way that the advancing mechanism is mounted with slight longitudinal play in the body 2. However, such play may have an adverse affect on the mechanical pencil quality perceived by the user because a rattling noise may be caused by the displacement of the advancing mechanism of the body 2 when the user shakes the mechanical pencil. It is therefore advantageous to provide an elastically deformable compensation member 50 in order to prevent any displacement of the advancing mechanism in he body of the mechanical pencil. It is therefore advantageous to provide an elastically deformable compensation member 50 in order to prevent any displacement of the advancing mechanism in the body of the mechanical pencil when the user does not actuate one or other of the control buttons (7, 47).

In the embodiment illustrated, the compensation member 50 is arranged between the front stop 4b of the body and the brush 40, but is clear that the compensation member could be arranged between the rear stop 27a of the body and the complementary stop 29 of the movable member.

As is more evident in FIG. 6 which illustrates the tip 4 of the body, the compensation member 50 is formed by two tabs 51 in the form of an arc of a circle which can be deformed elastically towards the front end 2\a. the ends of the tabs 51 are integral with the tip 4, so that the tabs 51 form one single part moulded together with the tip 4.

However, the compensation member 50 could, of course, be formed by an independent part, such as, for example, a compression spring of very small length. It is nevertheless preferable that the rigidity of the compensation member 50 is markedly lower than that of the spring 19, so that the bush 40 keeps the clamping ring 18 as far forward as possible on the head of the chuck.

The tube 3 forming the body of the mechanical pencil comprises two diametrically opposite studs 52 which extend radially inside the body 2 between the bush 40 and the movable member 20.

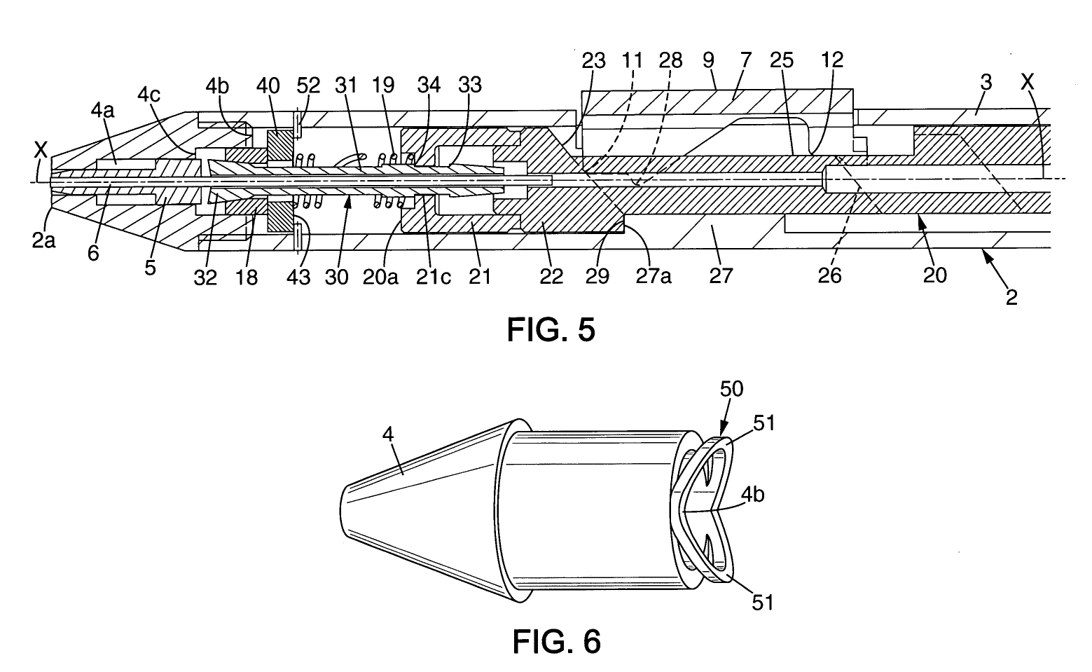

The stubs are arranged at a distance, measured from the rear face 43 of the bush in the rest position, which is equal to or slightly smaller than the rearward stroke of the chuck 30 with respect to the movable member 20. Thus, the rearward displacement of the bush 40 from the rest position and, consequently, the displacement of the ring 18 is limited to a value at most equal to the rearward stroke the chuck, the said value being called “the actual rearward stroke.” When the chuck 30 retracts under the effect of excessive pressure exerted by the user, the rearward of the ring 18 is stopped at the same time as or a little before the second rim 34 of the chuck comes into abutment against the orifice 21c of the movable member, as can be seen in FIG. 5. The effect of this is to increase the clamping force of the head 32 of the chuck on the lead 6 in a way which is directly proportional to the pressure exerted on the pencil by the user when the actual rearward stroke of the chuck has been achieved. Thus, from this maximum rearward position, it is virtually impossible to obtain any sliding of the lead in the head of the chuck.

It will be noted that, in the absence of the rearward movement stops 52, the clamping force of the head of the chuck on the lead would be constant and defined by the pressure exerted on the bush 40 by the spring 19 when the second rim 34 of the chuck comes into abutment against the movable member. Since the rigidity of the spring 19 cannot be too high, the user would obtain a sliding of the pencil in the chuck by exerting a pressure of the order of 15 to 20 newtons on the lead, which is possible. Yet such a sliding of the lead is annoying to the user, since it requires the actuation of the advancing mechanism in order to expel the lead once again. Moreover, the sliding of the lead clogs up the head of the chuck with graphite particles, thus reducing the efficiency of the head 32 clamping on the lead.

The spring 19 is a helical compression spring produced from metal. This type of spring has the advantage that it can be compressed over a long stroke, while maintaining constant rigidity. Furthermore, it is a standard part which is produced in large quantities and the rigidity of which is perfectly known and constant. However, it is conceivable to use, instead of such a spring, another elastic element, such as, for example, a plastic sleeve provided with orifices which allow a longitudinal compression of the latter.

The force exerted by the spring must be sufficiently high in order both to ensure a clamping of the ring 18 on the head 32 which makes it possible to block the lead 6 effectively and to allow retraction of the lead only when the user exerts a truly excessive pressure, that is to say markedly higher than that applied during normal writing.

The rigidity and off-load length of the spring would therefore be selected such that the pressure exerted on the bush is between 2 and 5 newtons, preferably 3 newtons, when the advancing mechanism is in a rest position.

The spring 19 will also be selected as a function of the dimensions of the advancing mechanism and especially of the rearward stroke, so as to exert a pressure of between 5 and 10 newtons, preferably 8 newtons, when the chuck has executed a rearward displacement equal to the actual rearward stroke of the lead.

The functioning of the mechanical pencil described above will be explained with the aid of FIGS. 2 to 5.

In the rest position, illustrated in FIG. 2, the clamping ring 18 keeps the head 32 of the chuck clamped on the lead 6 by means of the action of the spring 19. To be precise, the spring 19 exerts, on the one hand, a rearward pull on the chuck by means of the orifice 21c of the movable member which is in bearing contact against the first rim 33 of the chuck and, on the other hand, a forward push on the clamping ring 18 by means of the bush 40. In the rest position, that is to say without any actuation of the lateral button 7 or rear button formed by the element 46 and the rubber 47, the lead 6 is therefore kept blocked in the head 32 of the chuck.

With pressure being exerted on the actuation face 9 of the lateral button 7, a first forward displacement of the movable member 20 as far as a position illustrated in FIG. 3 is obtained as a result of the cooperation of the first pair of cams 11 of the button on the first pair of ramps 23 of the movable member, the second pair of cams 12 remaining in bearing contact on the bearing 25.

During this first displacement, a distinction can be made between two strokes of the movable member. The first stroke of approximately 2 mm, during which the orifice 21c of the movable member slides along the tubular portion of the chuck from the first rim 33 as far as the second rim 34, the chuck 30 remaining immobile during this first stroke. Then a second stroke, called the advancing stroke, during which the orifice 21c of the movable member is in abutment against the second rim 34 and the chuck 30 executes a forward displacement.

During the second stroke, the clamping ring 18 accompanies the movement of the head 32 of the chuck, and the lead is consequently displaced by a corresponding value. It will be noted that, during this second stroke, the lead guide tip 5 remains immobile in the bore 4a of the tip on account of the frictional force between the lead guide tip 5 and the tip 4 which is higher than the frictional force between the lead guide tip 5 and the lead 6.

Thus, after the first displacement of the movable member, and as can be seen in FIG. 3, the lead 6 projects beyond the front end of the lead guide tip 5 by a value equal to the second stroke, which is why it is called an advancing stroke. In the embodiment illustrated, this advancing stroke is substantially equal to one millimeter, that is to say approximately half the rearward stroke.

After this first displacement of the movable member 20, it is possible to control a second additional displacement of the latter, in order to obtain a complete emergency of the lead guide tip 5.

This second displacement can be obtained by continuing to exert pressure on the lateral button 7, thus bringing about a sliding of the second pair of cams 12 of the button along the second pair of ramps 26 of the movable member as far as a position illustrated in FIG. 4.

During the second displacement of the movable member 20, the head 32 of the chuck no longer grips the lead 6 on account of the retention of the ring 18 by a shoulder 4c of the tip 4, the said shoulder being formed at the rear end of the bore 4a. It will be noted that the ring 18 executes even a rearward movement due to the elasticity of the head 32. However, the head 32 of the chuck comes to be against the rear end of the lead guide tip 5, thus causing the emergence of the latter, accompanied by the lead 6. To be precise, even if the head of the chuck no longer grips the lead 6, the latter advances together with the lead guide tip 5 because of the frictional force existing between the lead guide tip and the lead.

From the position illustrated in FIG. 4, if the user relaxes pressure on the lateral button 7, the spring 19 pushes the movable member 20 rearwards, thus resulting in a return of the lateral button into the rest position on account of the action of the first 23 and second 26 pairs of ramps on the first 11 and second 12 pairs of cams.

During this rearward movement of the movable member, the chuck 30 also executes a rearward movement, but the head 32 remains open over virtually the entire length of this movement and the lead 6 executes virtually no retraction movement, so that the lead guide tip 5 remains in the expelled position.

At the end of this rearward movement, the advancing mechanism as a whole returns to the rest position, as illustrated in FIG. 2, and the head 32 of the chuck once again immobilizes the lead 6, but the lead and the lead guide tip 5 remain expelled, as illustrated in FIG. 4, so that the mechanical pencil is ready to be used.

The above-described advance of the lead is obtained by the actuation of the lateral button 7, but the actuation of the rear button would, of course, bring about a similar advance of the lead.

If, during writing, the user exerts excessive pressure on the lead 6 which is immobilized by the head 32 of the chuck, the lead and the chuck 30 move towards the rear end of the mechanical pencil owing to the longitudinal movability of the chuck with respect top the movable member 20.

During this rearward movement, the head 32 of the chuck drives the clamping ring 18 and the bush 40 rearwards, thus compressing the spring 19. Consequently, resistance to the rearward movement of the lead increases gradually during the rearward movement up to a maximum in the position illustrated in FIG. 5. This imparts a cushioning effect to the advancing mechanism. It will be noted that the movable member 20 remains immobile during the rearward movement of the pencil which consequently has no effect on the control buttons.

In the absence of the rearward movement stop 52, the actual rearward stroke of the lead is equal to the rearward stroke of the chuck with respect to the movable member, but the clamping force of the chuck on the lead no longer increases when the second rim 34 comes into abutment against the orifice 21c of the movable member.

In the presence of a rearward movement stop 52, the actual rearward stroke of the lead is preferably limited to a value slightly lower than the rearward stroke. However, when the lead has executed its actual retraction stroke, the clamping force of the head 32 of the chuck on the lead increases considerably since the ring 18 is then immobilized. This prevents a sliding of the lead in the head 32 of the chuck.

If the user reduces the pressure exerted on the lead, the latter returns to its initial position automatically by virtue of the action of the spring 19 which pushes the head 32 of the chuck forwards, and the mechanical pencil is ready to be used.

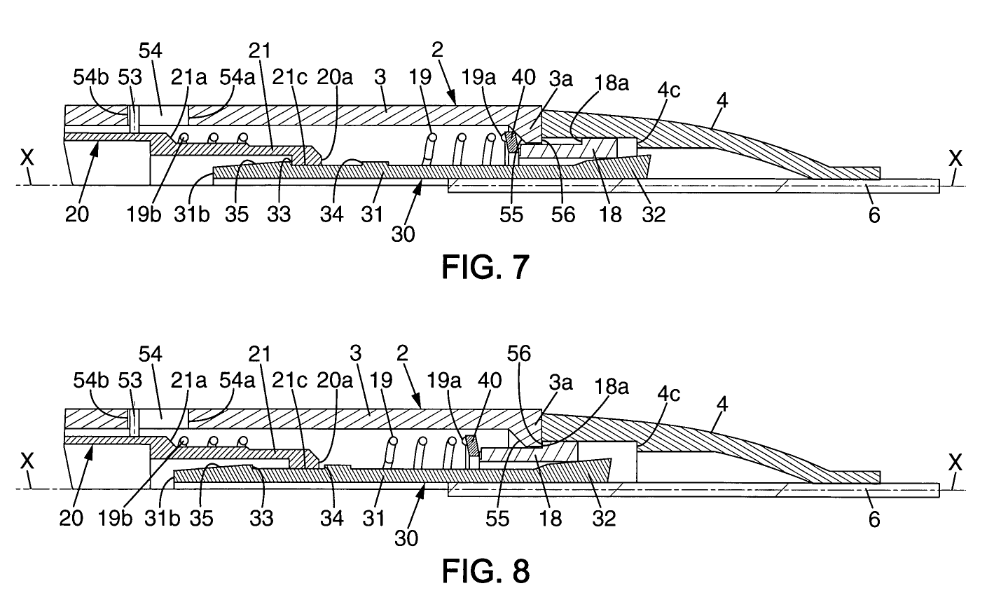

FIGS. 7 and 8 illustrate a second embodiment of a mechanical pencil. The tubular body 2 is likewise formed from a tube 3 and a tip 4, but the tip 4 does not comprise a lead guide tip.

As in the first embodiment, the advancing mechanism comprises a movable member 20, a chuck 30, a clamping ring 18, a bush 40 and a spring 19. In this embodiment, the advancing mechanism is controlled solely by a rear button, not illustrated in FIGS. 7 and 8.

The movable member 20 formed from a single front part 21 which has a frustoconical bearing face 21a which, however, is substantially oriented forwards and against which bears the rear end 19b of the spring. The part 21 of the movable member has, at its front end 20a, an orifice 21c, through which a chuck 30 entirely similar to the chuck of the first embodiment is mounted movably, so that the tubular portion 31 of the chuck slides in the orifice 21c between a first rim 33 and a second rim 34 over a defined stroke, called a rearward stroke.

In the second embodiment, the movable member 20 has a pin 53 which projects outward in aperture 54 extending longitudinally in the tube 3 between a front end 54a and a rear end 54b. The rear end 54b of the aperture 54 forms a rear stop of the body, the said stop cooperating with a complementary stop, formed by the pin 53, of the movable member, so as to limit the rearward displacement of the movable member 20.

The bush 20 is formed from a slightly conical washer, the forward displacement of which is limited by a stop 3a formed by a radially inner rim of the tube 3, said rim having a first face 55 oriented substantially towards the rear of the body.

The clamping ring 18 of this second embodiment has a radially outer shoulder 18a, and the radially inner rim 3a of the tube has a face 56 oriented towards the front end 2a of the body. The face 56 forms a rearward stop designed to limit the rearward movement of the clamping ring 18.

As in the first embodiment, the rear stop 54b and the front stop 55 of the body 2 must be sufficiently spaced apart longitudinally to ensure that the advancing mechanism firmly immobilizes the lead 6 when the said advancing mechanism is in the rest position illustrated in FIG. 7, that is to say the bush 40 must push the clamping ring 18 sufficiently forward in order that the head 32 of the chuck grips the lead.

The advance of the lead 6 is controlled by pressure on the rear button of the mechanical pencil, thus causing a forward displacement of the movable member 20, during which the orifice 21c comes into abutment against the second rim 34 of the chuck, then brings about a forward displacement of the chu8ck until the clamping ring 18 butts against a rim 4c of the tip and causes the opening of the head 32 of the chuck. The rearward movement of the chuck in an opened state is subsequently ensured by the spring 19. In the second embodiment, therefore, the advance of the lead is entirely similar to that of the first embodiment, although the tip 4 does not comprise a lead guide tip.

When the user exerts excessive pressure on the end of the lead 6, the chuck 30 moves rearward, at the same time sliding in the orifice 21c of the movable member and compressing the spring 19. During the rearward movement of the chuck, the movable member 20 remains in abutment against the rear stop 54b of the body.

When the lead has moved as far as the position illustrated in FIG. 8, shoulder 18a of the ring comes up against the rearward stop 56 of the body, thus increasing the clamping of the ring 18 on the head of the chuck 32 and thereby making it very difficult for the lead 6 to slide in the head 32.

As can be seen in FIG. 8, the second rim 34 of the chuck is not in contact with the orifice 21c of the movable member when the chuck is in the maximum rearward position. Consequently, in this embodiment, the actual rearward stroke of the lead 6 is lower than the rearward stroke of the chuck 30 with respect to the movable member.

As in the first embodiment, it is possible to obtain an actual rearward stroke which is substantially equal to double the advancing stroke of the lead. It is likewise perfectly possible to select a spring designed to exert on the bush 40 pressures substantially equal to those exerted in the first embodiment.

Of course, the two embodiments described above are not limiting, and, in particular, it is possible to combine different characteristics of the first and second embodiment.

1.-15. (canceled)

16. A mechanical pencil comprising a tubular body extending along a longitudinal axis between a rear end and a front end provided with an orifice, through which a lead is capable of emerging, and a lead-advancing mechanism arranged in the tubular body, said advancing mechanism comprises:
a longitudinally movable member having a forwardly oriented bearing surface;
a chuck having a tubular portion connected to said movable member, and a head capable of being clamped on the lead;
a clamping ring which is movable longitudinally with respect to said chuck and to the tubular body and which is designed to cooperate with the head of said chuck; and
an elastic element having a front end and a rear end bearing against the bearing surface of said movable member, said elastic element being designed to bias said clamping ring against the head of said chuck when said advancing mechanism is in a rest position,
wherein a bush, movable longitudinally with respect to said chuck and the body, is arranged between said clamping ring and the front end of said elastic element, in that said chuck is movable longitudinally with respect to said movable member over a defined stroke, and
wherein the body has a front stop designed to limit the forward displacement of the bush.

17. The mechanical pencil according to claim 16, wherein the front stop is formed by a radially inner rim which cooperates with a peripheral portion of the front end of the bush.

18. The mechanical pencil according to claim 16, wherein said elastic element is a helical compression spring.

19. The mechanical pencil according to claim 16, wherein the tubular portion of said chuck has, from its rear end, first and second radially outer rims, and wherein the front end of said movable member has an orifice, through which said chuck slides between the first and second rims, the said first and second rims being spaced apart longitudinally in order to limit this sliding of said chuck to a value equal to the defined stroke.

20. The mechanical pencil according to claim 19, wherein the tubular portion of said chuck has a frustoconical portion extending from the first rim as far as the rear end of said chuck.

21. The mechanical pencil according to claim 16, wherein the body has a rear stop designed to cooperate with a complementary stop of said movable member and to limit the rearward displacement of said movable member, the longitudinal distance between the front stop of the body and the rear stop being designed so that said clamping ring keeps said chuck clamped under the action of the bush when said advancing mechanism is in the rest position.

22. The mechanical pencil according to claim 21, wherein the rear stop is formed by a radially inner rim of the body, the rim cooperating with a radially outer shoulder of said movable member.

23. The mechanical pencil according to claim 16, wherein the body has an aperture extending longitudinally as far as a rear end, and wherein said movable member has a pin projecting into the aperture, the rear end of the aperture forming the rear stop.

24. The mechanical pencil according to claim 16, wherein at least one elastically deformable compensation member is arranged between the front stop of the body and the bush or between the rear stop of the body and the complementary stop of said movable member.

25. The mechanical pencil according to claim 24, wherein the compensation member comprises at least one tab elastically deformable in a longitudinal direction and produced in one piece with the body.

26. The mechanical pencil according to any of claim 16, wherein the body has a rearward movement stop designed to limit the rearward displacement of said clamping ring from the rest position of said advancing mechanism to a value at most equal to the defined stroke of said chuck.

27. The mechanical pencil according to claim 26, wherein the rearward movement stop is formed by at least one stud integral with the body and extending radially inwards between the bush and said movable member, the stud being designed to limit the rearward displacement of the bush.

28. The mechanical pencil according to claim 26, wherein the rearward movement stop is formed by a radially inner rim of the body, the rim being designed to cooperate with a radially outer shoulder of said clamping ring.

29. The mechanical pencil according to claim 16, wherein said chuck is capable of driving the lead forwards over a defined stroke from the rest position of said advancing mechanism.

30. The mechanical pencil according to claim 16, wherein said elastic element is designed to exert on the bush a pressure of about 2-5 newtons when said advancing mechanism is in the rest position, and a pressure of about 5-10 newtons when said chuck has executed a rearward displacement substantially equal to the defined stroke.

31. A mechanical pencil comprising a tubular body extending along a longitudinal axis between a rear end and a front end provided with an orifice, through which a lead is capable of emerging, and a lead-advancing mechanism arranged in the tubular body, said advancing mechanism comprises:
a longitudinally movable member having a forwardly oriented bearing surface;
a chuck having a tubular portion connected to said movable member, and a head capable of being clamped on the lead;
a clamping ring which is movable longitudinally with respect to said chuck and to the tubular body and which is designed to cooperate with the head of said chuck; and
an elastic element having a front end and a rear end bearing against the bearing surface of said movable member, said elastic element being designed to bias said clamping ring against the head of said chuck when said advancing mechanism is in a rest position,
wherein a bush, movable longitudinally with respect to said chuck and the body, is arranged between said clamping ring and the front end of said elastic element, in that said chuck is movable longitudinally with respect to said movable member over a defined stroke,
wherein the body has a front stop designed to limit the forward displacement of the bush, and
wherein the front stop is formed by a radially inner rim which cooperates with a peripheral portion of the front end of the bush.

32. A mechanical pencil comprising a tubular body extending along a longitudinal axis between a rear end and a front end provided with an orifice, through which a lead is capable of emerging, and a lead-advancing mechanism arranged in the tubular body, said advancing mechanism comprises:
a longitudinally movable member having a forwardly oriented bearing surface;
a chuck having a tubular portion connected to said movable member, and a head capable of being clamped on the lead;
a clamping ring which is movable longitudinally with respect to said chuck and to the tubular body and which is designed to cooperate with the head of said chuck; and
an elastic element having a front end and a rear end bearing against the bearing surface of said movable member, said elastic element being designed to bias said clamping ring against the head of said chuck when said advancing mechanism is in a rest position,
wherein a bush, movable longitudinally with respect to said chuck and the body, is arranged between said clamping ring and the front end of said elastic element, in that said chuck is movable longitudinally with respect to said movable member over a defined stroke,
wherein the body has a front stop designed to limit the forward displacement of the bush, and
said elastic element is a helical compression spring.
